(19) United States
(12) Patent Application Publication
(10) Pub. No.: US 2022/0130067 A1
(43) Pub. Date: Apr. 28, 2022

(54) POSITION ESTIMATION SYSTEM

(71) Applicant: Panasonic Corporation, Osaka (JP)

(72) Inventors: DUYHINH NGUYEN, Chiba (JP); ZHENG WU, Singapore (SG); ZHI TING TOH SHERYL, Singapore (SG); VENGATESAN GOVINDARAJU, Singapore (SG); PONGSAK LASANG, Singapore (SG); TAKESHI ANDO, Kyoto (JP)

(21) Appl. No.: 17/502,079

(22) Filed: Oct. 15, 2021

(30) Foreign Application Priority Data
Oct. 23, 2020 (JP) 2020-178006

(51) Int. Cl. G06T 7/70; G06K 9/00

(52) U.S. Cl. CPC G06T 7/70; G06K 9/00664

(57) ABSTRACT

A position estimation system includes a prior map creator that creates a plurality of environmental maps using a first capture, and a position recognizer that estimates a position of a moving body based on a plurality of feature points included in the plurality of environmental maps and a feature point included in image information from a second capture provided in the moving body, in which the first capture includes a plurality of first imaging devices, a pair of adjacent first imaging devices among the plurality of first imaging devices is disposed so that parts of imaging visual fields of the adjacent first imaging devices overlap, and the second capture includes a second imaging device having a same imaging visual field as an imaging visual field of at least one first imaging device among the plurality of first imaging devices.

### BACKGROUND

### 1. Technical Field

The present disclosure relates to a position estimation system for estimating a position of a moving body using an imaging device.

### 2. Description of the Related Art

As a position estimation system of a mobile robot, a system using Light Detection and Ranging (Lidar), which is a range sensor, is mainstream. In recent years, in order to reduce costs of a sensor, a position estimation system using a camera is also attracted attention. For example, the system is also used for automatic driving, and a Visual Simultaneous Localization And Mapping (VSLAM) technology is used (Raul Mur-Artal, J. M. M. Montiel and Juan D. Tardos, “ORB-SLAM: A Versatile and Accurate Monocular SLAM System.”, IEEE Transactions on Robotics, vol. 31, no. 5, 2015, pp. 1147-1163).

### SUMMARY

According to an aspect of the present disclosure, there is provided a position estimation system including a prior map creator that creates a plurality of environmental maps using a first capture, and a position recognizer that estimates a position of a moving body based on a plurality of feature points included in the plurality of environmental maps and a feature point included in image information from a second capture provided in the moving body, in which the first capture includes a plurality of first imaging devices, a pair of adjacent first imaging devices among the plurality of first imaging devices is disposed so that parts of imaging visual fields of the adjacent first imaging devices overlap, and the second capture includes a second imaging device having a same imaging visual field as an imaging visual field of at least one first imaging device among the plurality of first imaging devices.

### BRIEF DESCRIPTION OF THE DRAWINGS

FIG. 1 is a schematic diagram of a position estimation system according to an exemplary embodiment of the present disclosure;

FIG. 2A is a schematic plan view of an image acquisition device according to the exemplary embodiment of the present disclosure;

FIG. 2B is a schematic front view of the image acquisition device according to the exemplary embodiment of the present disclosure;

FIG. 3A is a schematic plan view showing a relationship between fitting positions of respective first imaging devices placed on the image acquisition device according to the exemplary embodiment of the present disclosure;

FIG. 3B is a schematic perspective view showing a fitting state of the first imaging device according to the exemplary embodiment of the present disclosure;

FIG. 4 is a schematic view of an acquired image of the imaging device according to the exemplary embodiment of the present disclosure;

FIG. 5 is a schematic view of acquired images of adjacent imaging devices according to the exemplary embodiment of the present disclosure;

FIG. 6A is a schematic plan view showing a fitting state of a second imaging device according to the exemplary embodiment of the present disclosure;

FIG. 6B is a schematic side view showing the fitting state of the second imaging device according to the exemplary embodiment of the present disclosure;

FIG. 7A is a detailed plan view showing an example of the fitting state of the second imaging device according to the exemplary embodiment of the present disclosure;

FIG. 7B is a detailed plan view showing another example of the fitting state of the second imaging device according to the exemplary embodiment of the present disclosure;

FIG. 8 is an explanatory diagram of a general method for generating a feature map;

FIG. 9 is an explanatory diagram of a general method for generating a plurality of feature maps;

FIG. 10 is a schematic diagram in a case where the plurality of feature maps are generated according to the exemplary embodiment of the present disclosure;

FIG. 11 is an explanatory diagram of the method for generating the feature map according to the exemplary embodiment of the present disclosure;

FIG. 12 is an explanatory diagram of a rotation operation of a map generation moving body in the case where the feature map is generated according to the exemplary embodiment of the present disclosure;

FIG. 13 is an explanatory diagram of the method for generating the feature map according to the exemplary embodiment of the present disclosure, and is an explanatory diagram focusing on an operation of the map generation moving body at a specific connection point;

FIG. 14 is a flowchart showing an outline of a general position recognition process;

FIG. 15 is an explanatory diagram of re-localization of the general position recognition process;

FIG. 16 is an explanatory diagram of tracking of the general position recognition process;

FIG. 17 is an explanatory diagram of the general position recognition process in a case where a moving body main body rotates;

FIG. 18 is an explanatory diagram of the position recognition process in a case where the moving body main body rotates according to the exemplary embodiment of the present disclosure;

FIG. 19 is a flowchart showing an outline of the position recognition process according to the exemplary embodiment of the present disclosure; and

FIG. 20 is an explanatory diagram of experimental results of the position recognition process according to the exemplary embodiment of the present disclosure.

### DETAILED DESCRIPTIONS

In a case where the technology disclosed in Raul Mur-Artal, J. M. M. Montiel and Juan D. Tardos, “ORB-SLAM: A Versatile and Accurate Monocular SLAM System.”, IEEE Transactions on Robotics, vol. 31, no. 5, 2015, pp. 1147-1163 is applied to a mobile robot, the following restrictions occur.

A progress direction on a movement path of the robot is the same at each time.

The movement path of the robot is limited to a path moved in a case where a map is created in advance.

In a case of a robot that transports an object on a determined path, such as a factory, problems do not occur even though the above-described restrictions are applied. However, in a case of a mobile robot for a free traveling service in a public facility or the like, problems occur. For example, the mobile robot operating in the public facility or the like takes an evasive action according to the traffic of people, so that the movement path is not always constant. Further, even in a case of a mobile robot, which moves according to a work, faces various angles at various positions, so that the movement path is not always constant.

Therefore, in order to solve such a problem, there is provided a method for creating a map including information on all angles of all areas by placing cameras of various orientations (for example, four cameras whose orientations differ from each other by 90 degrees) on a target in a case where a map is created in advance, and by traveling the target, on which the cameras are placed, from corner to corner of a traveling environment. With the method, in a case where the position is estimated, the position can be estimated regardless of the position and the angle at which the mobile robot is facing.

However, in this case, since the map information increases by the number of cameras placed on the target, it takes time to estimate the position, so that a problem occurs in that the position cannot be estimated according to a speed of the mobile robot.

The present disclosure is to provide a position estimation system that can estimate a position of a moving body without being delayed in relation to movement of the moving body.

Hereinafter, an exemplary embodiment of the present disclosure will be described with reference to the accompanying drawings. In addition, for easy understanding, each of the drawings schematically shows each component as a subject.

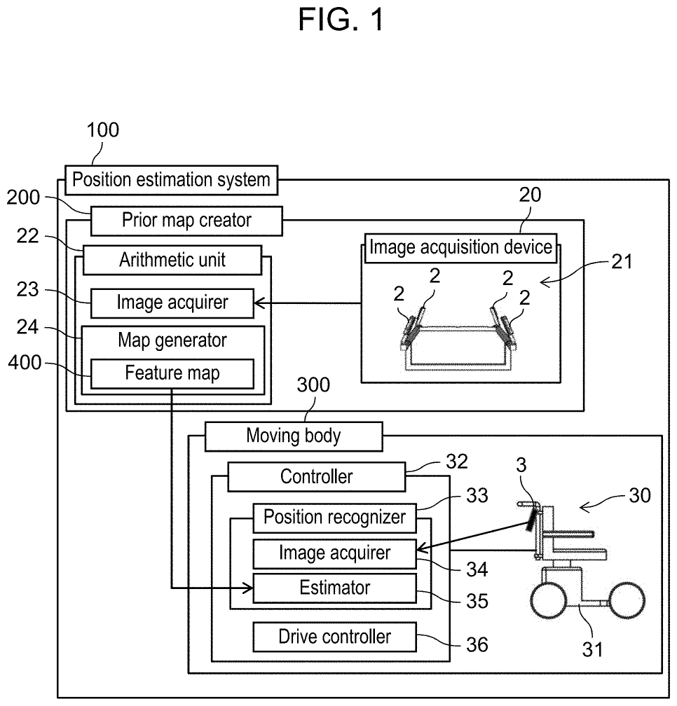

First, a configuration of position estimation system 100 according to the exemplary embodiment of the present disclosure will be described. FIG. 1 is a schematic diagram of position estimation system 100 according to the exemplary embodiment of the present disclosure.

As shown in FIG. 1, position estimation system 100 includes prior map creator 200 and moving body 300.

Prior map creator 200 includes image acquisition device 20 and arithmetic unit 22.

Image acquisition device 20 includes first capture 21 for acquiring an image. First capture 21 includes a plurality of first imaging devices 2.

Arithmetic unit 22 includes a computer and calculates feature map 400. Feature map 400 is an example of an environmental map. Feature map 400 will be described later. Arithmetic unit 22 includes image acquirer 23 that acquires and preserves an image from image acquisition device 20, and map generator 24 that generates feature map 400 for position recognition from the acquired image. In the present exemplary embodiment, an ORB feature value, which is disclosed in Raul Mur-Artal, J. M. M. Montiel and Juan D. Tardos, “ORB-SLAM: A Versatile and Accurate Monocular SLAM System.”, IEEE Transactions on Robotics, vol. 31, no. 5, 2015, pp. 1147-1163, is used as a feature value used in a case where a map is generated. However, other feature values may be used as long as the feature values can be used in a case of VSLAM.

Moving body 300 includes second capture 30, moving body main body 31, and controller 32.

Second capture 30 includes at least one second imaging device 3 fitted to moving body main body 31. Second imaging device 3 includes a lens, an image sensor, and the like that are the same as in first imaging device 2. Specifically, second imaging device 3 has the same imaging visual field as first imaging device 2. In the present exemplary embodiment, since the ORB feature value is used in the case where the map is generated, a process can be simplified by making configurations of first imaging device 2 and second imaging device 3 the same. However, first imaging device 2 and second imaging device 3 may have different configurations depending on the feature value used in the case where the map is generated.

Controller 32 includes position recognizer 33 for recognizing a position of moving body 300 and drive controller 36 for controlling drive of moving body 300.

Position recognizer 33 includes image acquirer 34 that fetches an image of second imaging device 3 fitted to moving body 300, and estimator 35 that estimates the position using the image and feature map 400 received from prior map creator 200.

Position estimation system 100, as a first step, generates feature map 400 by prior map creator 200 and preserves generated feature map 400 in controller 32 of moving body 300. Next, position recognizer 33 of moving body 300, as a second step, estimates the position using preserved feature map 400.

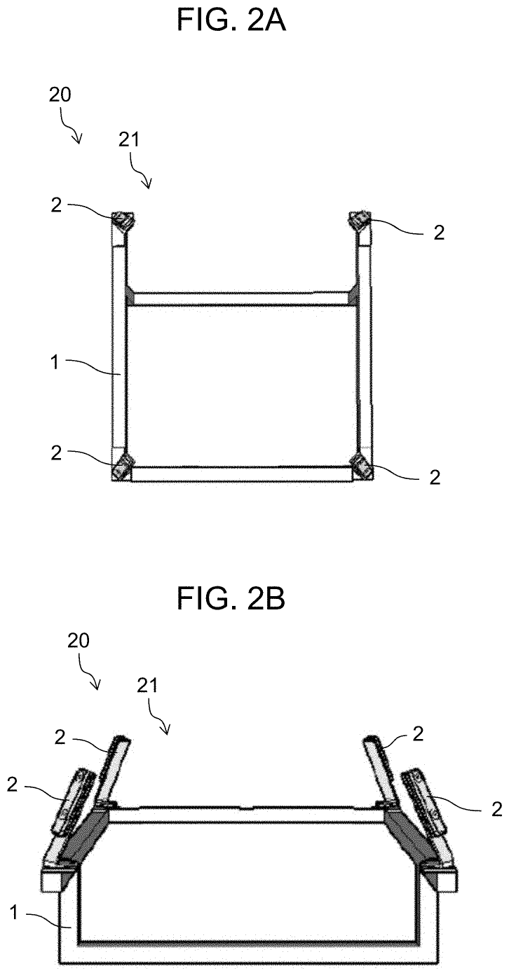

Next, a configuration of image acquisition device 20 will be described in detail. FIG. 2A is a schematic plan view of the image acquisition device, and FIG. 2B is a schematic front view of the image acquisition device.

As shown in FIGS. 2A and 2B, image acquisition device 20 includes frame 1 and first capture 21 including a plurality of first imaging devices 2. In the present exemplary embodiment, first capture 21 includes four first imaging devices 2. However, the number of first imaging devices 2 may be changed according to a configuration of a lens used for first imaging device 2.

The number of first imaging devices 2 needs to be set so that the following two conditions are satisfied. First, all first imaging devices 2 can secure a visual field capable of imaging an entire periphery of image acquisition device 20. Second, respective first imaging devices 2 have imaging visual fields, parts of which overlap. A degree of the overlap will be described later.

In a case where feature map 400 is actually generated, image acquisition device 20 is placed on any map generation moving body (it is not necessary to travel by itself) to acquire an image by moving the map generation moving body in an environment where the map is actually desired to be created.

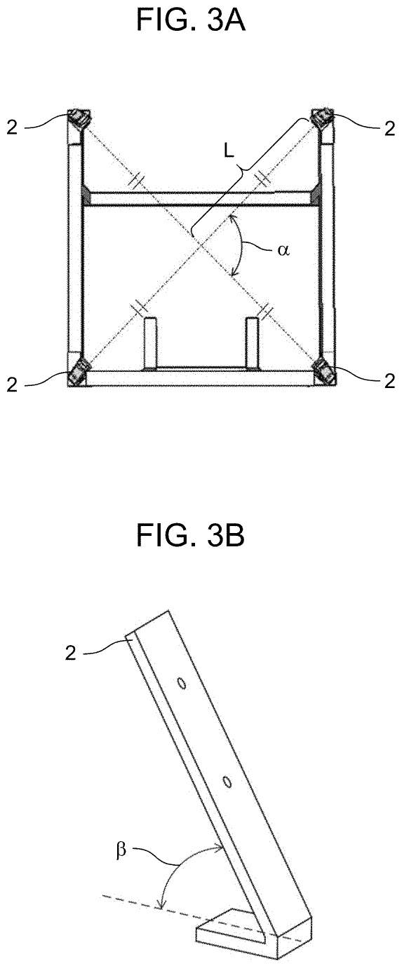

A fitting state of each first imaging device 2 will be described. FIG. 3A is a schematic plan view showing a relationship between fitting positions of the respective first imaging devices placed on the image acquisition device, and FIG. 3B is a schematic perspective view showing the fitting state of the first imaging device.

As shown in FIG. 3A, each first imaging device 2 is fixed at a position symmetrical with respect to a center of image acquisition device 20.

Specifically, lines connecting first imaging devices 2 facing each other while opposing across the center of image acquisition device 20 intersect at a midpoint of the lines, and all angles formed by the lines become angle α. That is, angle α is 360°/(the number of fitted first imaging devices 2). Further, all distances from each of first imaging devices 2 to the midpoint of the image acquisition device 20 become L. Further, as shown in FIG. 3B, each of first imaging devices 2 is installed in a direction such that the midpoint of image acquisition device 20 is positioned on a back side at the same elevation angle β with respect to the ground.

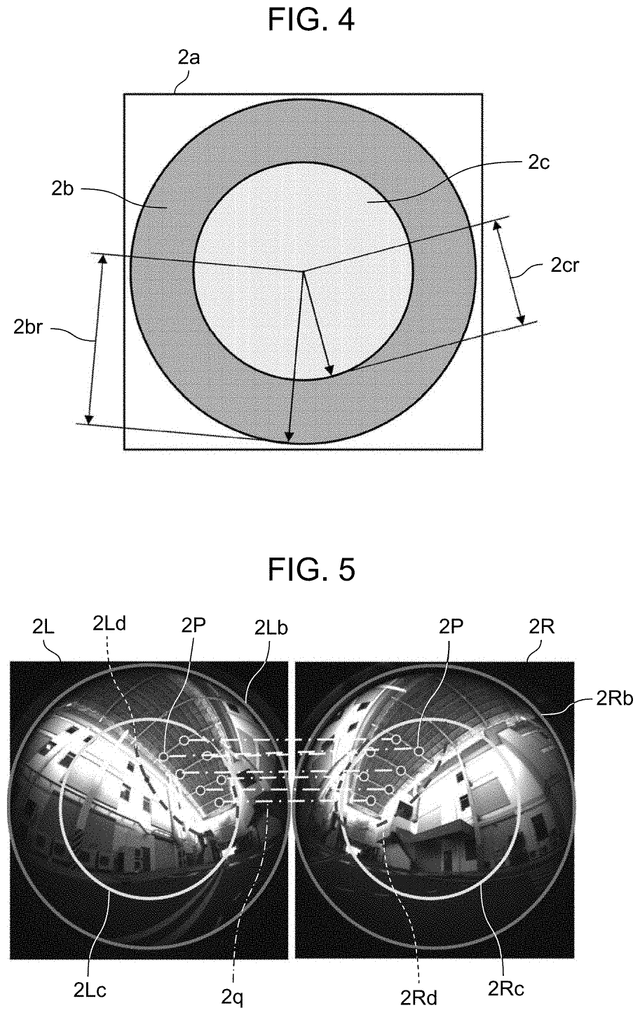

Next, a range, in which the imaging visual field of each first imaging device 2 overlaps, will be described. In the present exemplary embodiment, a fisheye lens capable of securing a visual field in a wide range is adopted as a lens of first imaging device 2. FIG. 4 is a schematic view of an acquired image of the first imaging device. FIG. 5 is a schematic view of acquired images of the adjacent first imaging devices.

Processed image 2a shown in FIG. 4 shows an entire image to be processed. Capturable range 2b shows a visual field that can be imaged by the fisheye lens in the whole processed image 2a. Normally, in a case where the fisheye lens is used, distortion increases as a distance from a center of an image increases, so that a range corresponding to a predetermined distance from the center is used for image processing. This area is referred to as effective range 2c. A size of the effective range greatly varies depending on a type of the feature value used in a case where feature map 400 is generated. In the present exemplary embodiment, the ORB feature value is used. In a case where a radius of capturable range 2b of the fisheye lens is 2br and a radius of effective range 2c is 2cr, 2cr/2br is 0.6.

Reference numeral 2R shown in FIG. 5 indicates a capture image by first imaging device 2 on a right side when viewed from between the fitting positions of two adjacent first imaging devices 2, and reference numeral 2L indicates a capture image by first imaging device 2 on a left side. Reference numerals 2Lb and 2Rb indicate capturable ranges of respective captured images 2R and 2L. Reference numerals 2Lc and 2Rc indicate effective ranges of respective captured image 2R and 2L. In the present exemplary embodiment, setting is performed so that the ORB feature values are uniformly detected within effective ranges 2Lc and 2Rc. On average, in respective captured images 2R and 2L, 320 feature values are respectively extracted within capturable ranges 2Lb and 2Rb.

Reference numerals 2Ld and 2Rd indicate a part (common area part) that is a mutually common area in effective ranges 2Lc and 2Rc of first imaging devices 2 on the left and right sides. That is, in common area parts 2Ld and 2Rd, the same ORB feature values 2P can be obtained even when viewed from either first imaging device 2 on the left or right side. Between the same ORB feature values 2P respectively existing in common area parts 2Ld and 2Rd are connected by one-dot chain lines indicated by reference numeral 2q. Although seven ORB feature values respectively exist in common area parts 2Ld and 2Rd in FIG. 5, reference numeral 2P is attached only for each one ORB feature value. Further, reference numeral 2q is attached for only one one-dot chain line of seven one-dot chain lines. In order to improve accuracy of a map, it is desirable to overlap the imaging visual fields of respective first imaging devices 2 so that a plurality of common ORB feature values 2P are included in areas of common area parts 2Ld and 2Rd. However, in a case where a ratio of the overlapping imaging visual fields increases, that is, in a case where common area part 2Ld of effective range 2Lc and common area part 2Rd of effective range 2Rc increase, the larger number of first imaging devices 2 is required for the increase, so that cost increases. In the present disclosure, each first imaging device 2 may be disposed so that at least four ORB feature values 2P are included. Specifically, each first imaging device 2 is disposed to include at least four common feature points inside the overlapping imaging visual field of adjacent first imaging devices 2 in a case where feature points, which can be acquired based on the image information from each first imaging device 2, are uniformly distributed in the imaging visual field of each first imaging device 2.

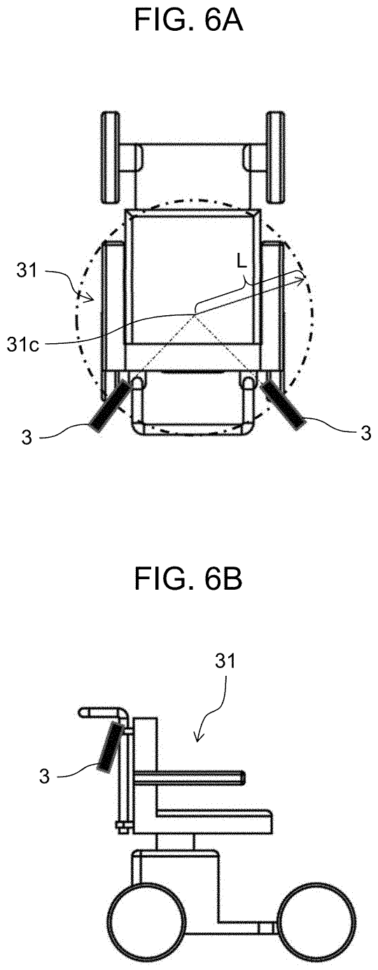

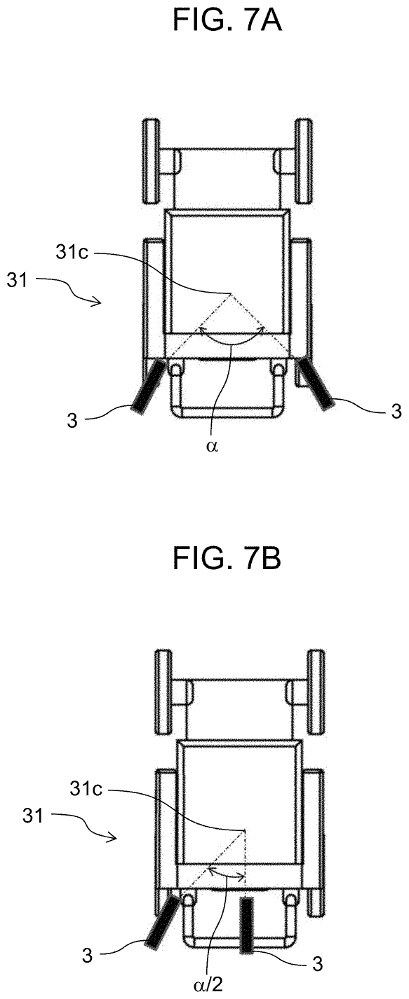

Next, a fitting position of second imaging device 3 of moving body main body 31 will be described in detail. FIG. 6A is a schematic plan view showing a fitting state of the second imaging device, and FIG. 6B is a schematic side view showing a fitting state of the second imaging device. FIG. 7A is a detailed plan view showing an example of the fitting state of the second imaging device, and FIG. 7B is a detailed plan view showing another example of the fitting state of the second imaging device.

It is basically desired that second imaging device 3 is provided at the same position as first imaging device 2 in a case where image acquisition device 20 acquires an image. For example, it is desired that a fitting height of second imaging device 3 is equivalent to a height of first imaging device 2 in a case where image acquisition device 20 acquires an image in an environment where a map is actually desired to be created. Further, it is desired that second imaging device 3 is installed at a fitting angle corresponding to the same elevation angle β as first imaging device 2 with respect to the ground.

As shown in FIGS. 6A and 6B, the fitting positions of the plurality of second imaging devices 3 may be on any of circumferences of distance L from center 31c of moving body main body 31, and a back surface of second imaging device 3 may face center 31c of moving body main body 31. In the present exemplary embodiment, in consideration of a risk in a case where a person walks around moving body main body 31 and covers the visual field of second imaging device 3, two second imaging devices 3 are installed in moving body main body 31 so that any one of second imaging devices 3 can surely capture an image of surrounding environment, but at least one second imaging device 3 may be installed.

In a case where a plurality of second imaging devices 3 are installed, an angle formed by lines connecting respective second imaging devices 3 and center 31c of moving body main body 31 may be a as the same as in first imaging device 2 of image acquisition device 20 as shown in FIG. 7A, but may be other angles. Theoretically, in a case where the angle is angle α as the same as in first imaging device 2 and moving body main body 31 rotates by angle α, the position of each second imaging device 3 becomes the exactly same position as first imaging device 2. However, for example, in a case where moving body main body 31 rotates by angle α/2, each second imaging device 3 is at a position different from the position of first imaging device 2. Basically, the position estimation is more stable in a case where second imaging device 3 of moving body main body 31 exists at the position of first imaging device 2 of image acquisition device 20. Therefore, as shown in FIG. 7B, in a case where the fitting angle of each second imaging device 3 is set to α/2, the position of one second imaging device 3 can be set to the same position as first imaging device 2 of image acquisition device 20 even in a case where moving body main body 31 rotates by angle α/2. However, in the application of the present exemplary embodiment, moving body main body 31 moves straight in many cases, so that, even in a case where the fitting angle is set to angle α and any one of two second imaging devices 3 is blocked by an obstacle, position estimation is stable.

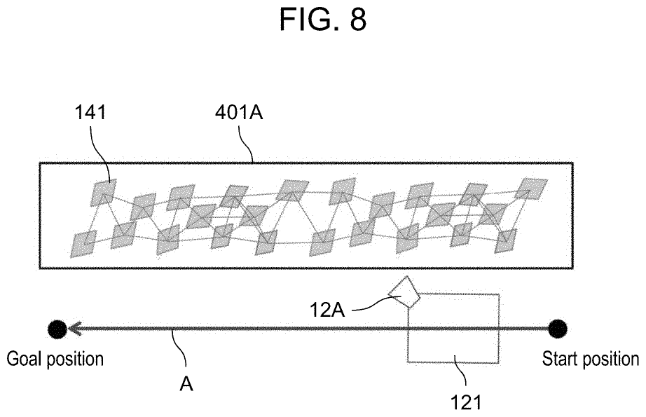

Next, a method for generating the feature map, which is the first step, will be described. FIG. 8 is an explanatory diagram of a general method for generating the feature map. As the method for generating the feature map, for example, the “ORB-SLAM” method disclosed in Raul Mur-Artal, J. M. M. Montiel and Juan D. Tardos, “ORB-SLAM: A Versatile and Accurate Monocular SLAM System.”, IEEE Transactions on Robotics, vol. 31, no. 5, 2015, pp. 1147-1163 can be used.

As shown in FIG. 8, feature map 401A includes a plurality of key frames 141. Key frame 141 is a frame of an image in which a feature value viewed from a relevant position is preserved. In a case where each key frame 141 (excluding a first one) is created, each key frame 141 is generated based on adjacent key frames 141. Therefore, a positional relationship between adjacent key frames 141 is registered for each key frame 141.

In a case where feature map 401A is generated, the image of the environment is acquired while image acquisition device 121 is operated in the environment where feature map 401A is desired to be created, as shown in FIG. 8. For simplification of description, the description will be given in a state where only one first imaging device 12A is placed.

For example, in a case where feature map 401A as shown in FIG. 8 is generated, first, image acquisition device 121 is moved from a start point to a goal point in FIG. 8 as shown by arrow A. At this time, first imaging device 12A of image acquisition device 121 preserves all images as a moving image. Next, images acquired at constant time intervals are extracted from the moving image, and feature map 401A is generated using the extracted images.

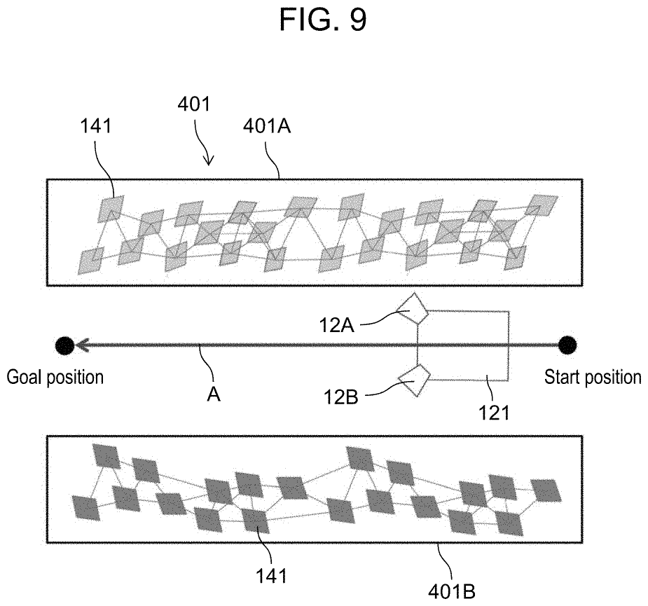

Next, a general method for generating a plurality of feature maps will be described. FIG. 9 is an explanatory diagram of the general method for generating a plurality of feature maps. In general, as shown in FIG. 9, another first imaging device 12B adjacent to first imaging device 12A can also generate feature map 401B in the same manner. However, in this case, feature map 401A and feature map 401B are respectively independent maps.

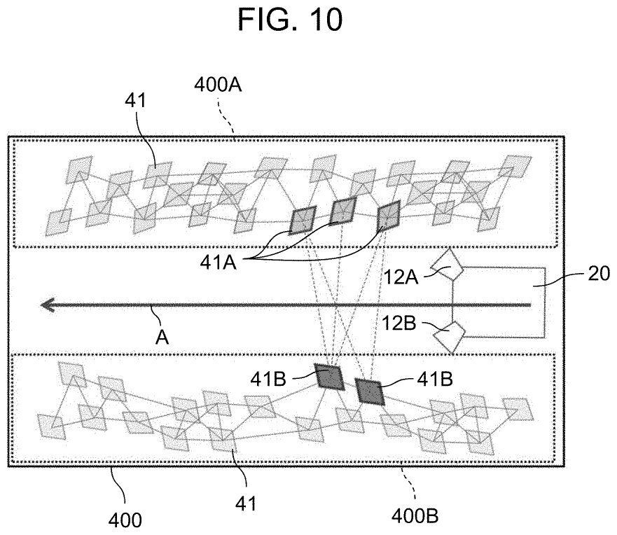

Next, the feature map generated in the present disclosure will be described. FIG. 10 is an explanatory diagram of the method for generating a plurality of feature maps according to the exemplary embodiment of the present disclosure. Here, typical key frame 41 will be used for description. Further, a step is assumed in which feature map 400A included in feature map 400 is already generated and feature map 400B included in feature map 400 is to be generated from now on.

First, typical key frames 41A included in feature map 400A shown in FIG. 10 are generated based on an image captured by first imaging device 12A. On the other hand, typical key frames 41B included in feature map 400B are generated based on an image captured by first imaging device 12B.

Here, first imaging device 12A and first imaging device 12B are adjacent to each other, and, in a case where a direction of arrow A is set as the progress direction, an imaging device on a right side is first imaging device 12A and an imaging device on a left side is first imaging device 12B. Further, the effective range of the image acquired by first imaging device 12A is the range indicated by reference numeral 2Rc shown in FIG. 5, and the effective range of the image acquired by first imaging device 12B is the range indicated by reference numeral 2Lc shown in FIG. 5.

In the method of the present disclosure, common ORB feature values 2P exist in the effective ranges of adjacent first imaging devices 12A and 12B. Therefore, in a case where typical key frames 41B of feature map 400B are generated, it is possible to associate a positional relationship of the adjacent key frames 41, but ORB feature values 2P included in typical key frames 41A are also included in an image captured by first imaging device 12B. Therefore, it is possible to calculate a positional relationship between typical key frames 41B and typical key frames 41A existing in feature map 400A generated by another first imaging device 12A, so that it is possible to register the positional relationship between the mutual key frames.

In this way, a map can be generated as one feature map 400 by adding key frames of feature map 400B using the image captured by first imaging device 12B based on feature map 400A. Generated feature map 400 is previously preserved in estimator 35 existing in controller 32 of moving body main body 31.

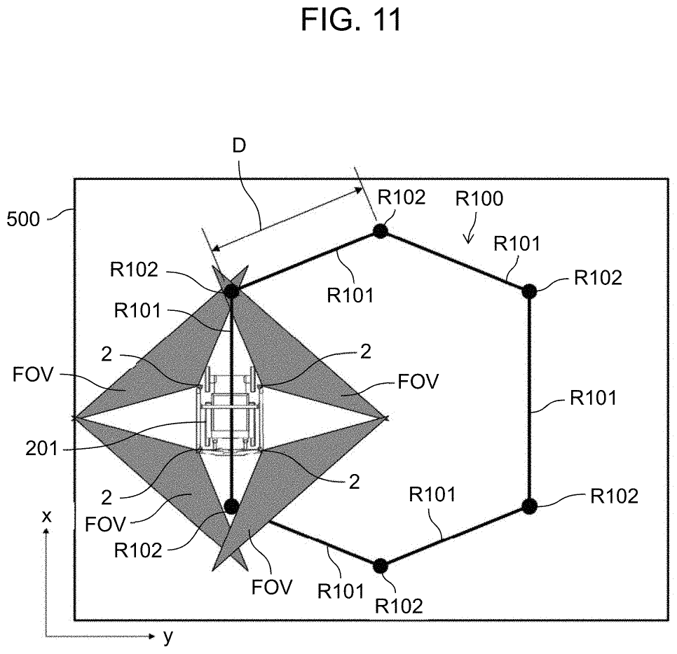

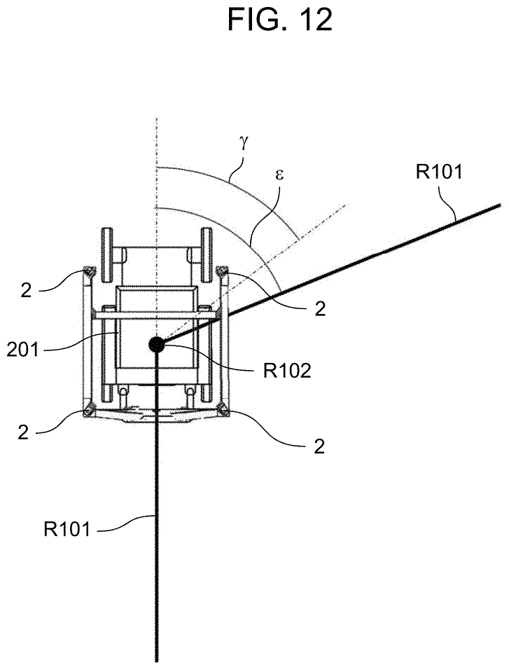

As described above, in a case where feature map 400 is generated, the plurality of first imaging devices 2 are placed on the map generation moving body. The generation of feature map 400 using the plurality of first imaging devices 2 will be described in detail. FIG. 11 is an explanatory diagram of the method for generating a feature map. FIG. 12 is an explanatory diagram of a rotation operation of the map generation moving body in the case where the feature map is generated.

As shown in FIG. 11, the plurality of first imaging devices 2 are placed on map generation moving body 201. In a case where feature map 400 is generated, map generation moving body 201 travels along route R100 in room 500. Effective visual field angles FOV of adjacent first imaging devices 2 are in an overlapping state (the imaging visual fields of adjacent first imaging devices 2 overlap).

Route R100 includes a plurality of straight lines R101 and a plurality of connection points R102 connecting adjacent straight lines R101. In a case where a combination of straight line R101 and connection point R102 is changed, it is possible to change travel route R100 of map generation moving body 201 into various shapes.

In a case where feature map 400 is generated, it is desired that travel route R100 is set so that image acquisition device 20 can fetch a situation in room 500 as an image in a wide range. More specifically, as shown in FIG. 12, in order to acquire the feature value required for self-position estimation, it is desired to rotate map generation moving body 201 on connection point R102 at an angle which is equal to or greater than a specified angle γ. For example, in the present exemplary embodiment, each first imaging device 2 is disposed so that angle α shown in FIG. 3A becomes 90°. Therefore, in each first imaging device 2, it is desired to set angle γ to 45° at which it is difficult to obtain the feature value because it is an edge of the image.

Further, it is desired that setting is performed such that a distance between respective connection points R102 is equal to or less than any threshold value D. However, the distance cannot be uniquely determined because the distance depends on resolution of each first imaging device 2, a size of room 500, or the like.

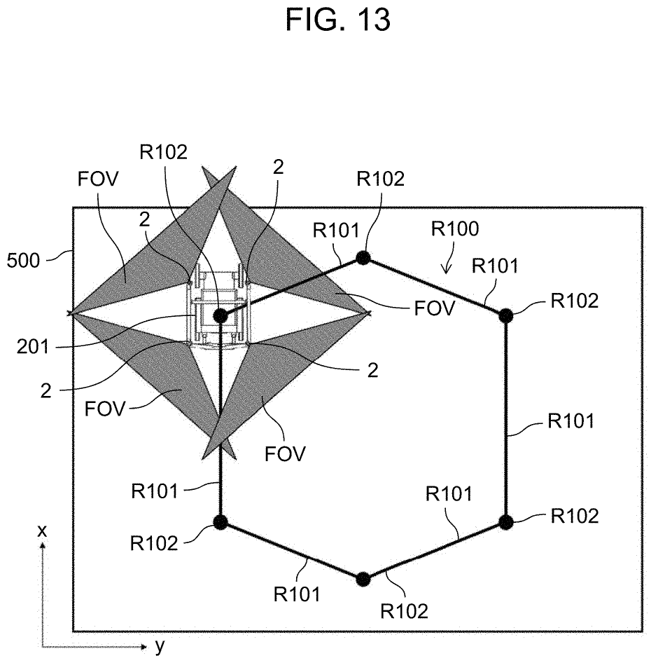

Next, in a case where feature map 400 is generated, an operation performed in a case where map generation moving body 201 actually travels on route R100 will be described. FIG. 13 is an explanatory diagram of the method for generating a feature map, and is an explanatory diagram focusing on the operation of the map generation moving body at a specific connection point.

In a case where map generation moving body 201 reaches any connection point R102 while progressing in an X direction shown in FIG. 13, map generation moving body 201 temporarily stops and performs a rotation operation in order to change a course to straight line R101 to be progressed next. At this time, an angle for directing map generation moving body 201 in a direction of next connection point R102 is ε as shown in FIG. 12. In a case where a relationship of “ε≥γ” is satisfied, map generation moving body 201 starts traveling along straight line R101 in a step at which a rotation angle reaches angle ε. On the other hand, in a case where a relationship of “ε<γ” is satisfied, map generation moving body 201 continues to rotate until the rotation angle becomes γ, and, thereafter, rotates in an opposite direction so that the rotation angle becomes ε and starts traveling along straight line R101. While map generation moving body 201 is traveling, image acquirer 23 of prior map creator 200 acquires the image of the environment from first imaging device 2, and the map generator 24 generates feature map 400 based on the acquired image.

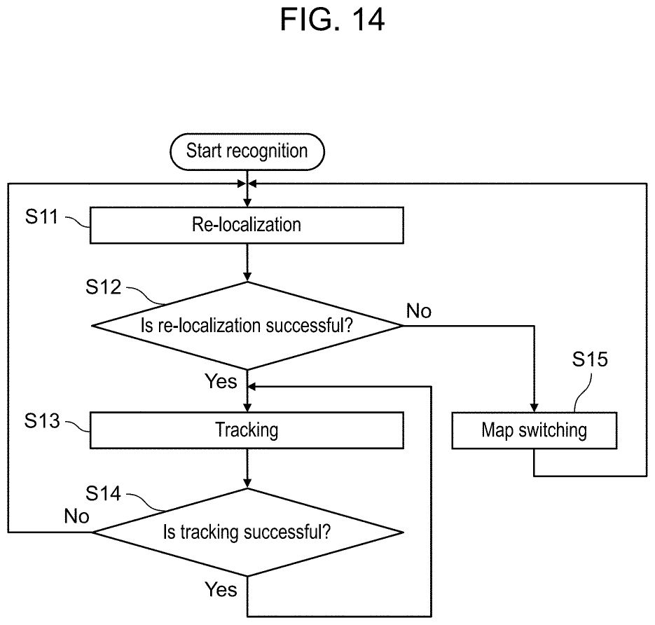

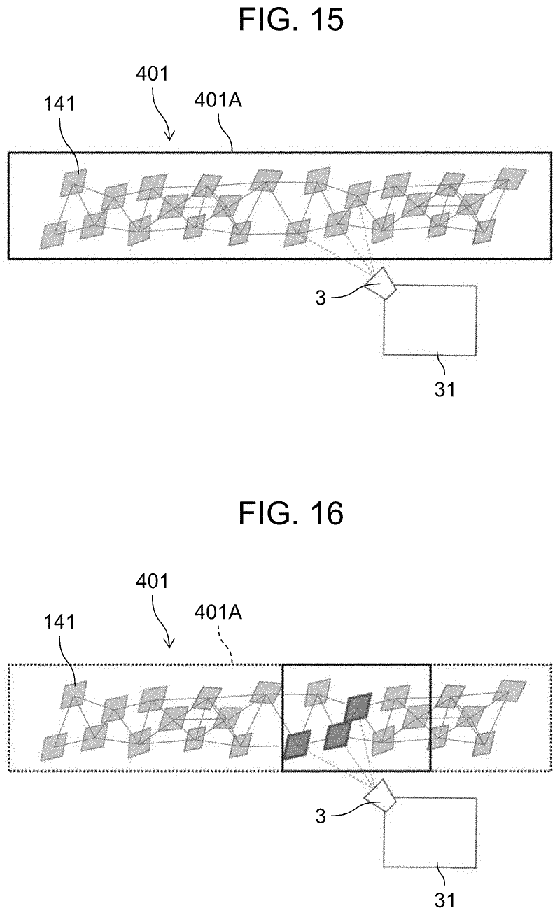

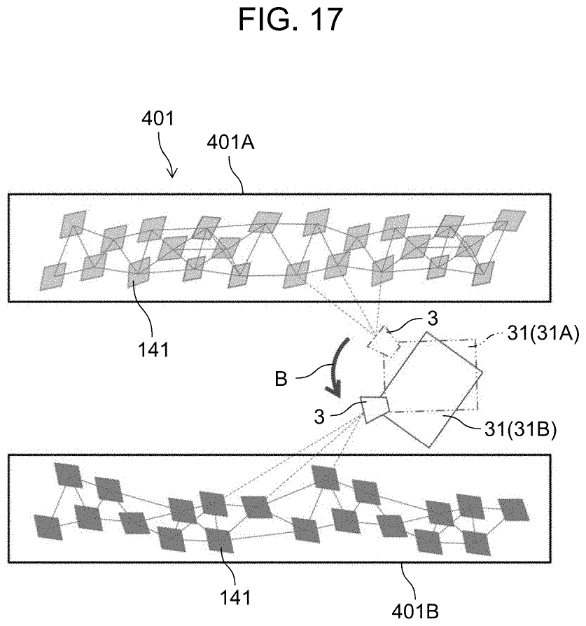

Next, a general position recognition process will be described. FIG. 14 is a flowchart showing an outline of the general position recognition process. FIG. 15 is an explanatory diagram of re-localization of the general position recognition process. FIG. 16 is an explanatory diagram of tracking of a general position recognition process. FIG. 17 is an explanatory diagram of the general position recognition process in a case where the moving body main body rotates.

The position recognition process in the “ORB-SLAM” mainly includes step S11 for performing re-localization and step S13 for performing tracking.

First, an overall flow of the general position recognition process will be described. In the position recognition process, as shown in FIG. 14, the re-localization is performed (step S11). Next, it is determined whether or not the re-localization is successful (step S12), and, in a case where it is determined that the re-localization is successful (step S12: YES), the tracking is performed (step S13). After that, it is determined whether or not the tracking is successful (step S14), and, in a case where it is determined that the tracking is successful (step S14: YES), for example, moving body main body 31 is moved to perform the tracking (step S13). On the other hand, in a case where it is determined that the tracking fails (step S14: NO), for example, moving body main body 31 is stopped to perform the re-localization (step S11). Further, in a case where it is determined that the re-localization fails (step S12: NO), the feature map of a search target is switched (step S15), and the re-localization is performed (step S11).

Here, as shown in FIG. 15, the re-localization in step S11 is, for example, searching all key frames 141 included in feature map 401A for key frame 141 having the same feature point as a feature point in an image acquired by second imaging device 3.

On the other hand, the tracking in step S13 is searching only key frames 141 (key frames 141 surrounded by a solid line in FIG. 16) in the vicinity of key frame 141 recognized in an immediately pervious process for key frames 141 having the same feature point as the feature point in the image acquired by second imaging device 3.

In general, the re-localization in step S11 shown in FIG. 14 has a property of taking time because the search is performed from the entire feature map 401A. On the other hand, in the tracking in step S13, since the number of key frames 141 to be searched is small, the search can be performed faster than the re-localization in step S11. Therefore, normally, before moving body main body 31 starts moving, the position is estimated by performing the re-localization in step S11, and, in a case where the re-localization is successful (step S12: YES), the position is estimated by performing the tracking in step S13 thereafter. Therefore, once the tracking in step S13 starts, there is no problem even in a case where moving body main body 31 moves, and the position can be always estimated as long as the tracking is successful (step S14: YES). However, as shown in FIG. 14, in a case where the position cannot be estimated by the tracking in step S13 (step S14: NO), the position of moving body main body 31 needs to be searched again from the entire feature map 401A, so that it is necessary to perform search again from the re-localization in step S11. At this time, moving body main body 31 stops because the position is unknown, and starts moving again after the re-localization in step S11 ends. As described above, in order for moving body main body 31 to move smoothly, it is important that the tracking in step S13 can be continued as long as possible.

In general, the tracking in step S13 always fails in a case where next corresponding key frame 141 does not exist in the same feature map 401 as currently corresponding key frame 141. For example, as shown in FIG. 17, the case is a case where moving body main body 31 rotates on the spot in a direction of arrow B. In a case where the moving body main body 31 is in a state of reference numeral 31A indicated by a two-dot chain line in FIG. 17, second imaging device 3 corresponds to key frames 141 of feature map 401A. However, in a case where moving body main body 31 rotates to a state of arrow B indicated by the solid line of FIG. 17, second imaging device 3 corresponds to key frames 141 of feature map 401B. At this time, since feature map 401, to which corresponding key frames 141 belong, is switched from feature map 401A to feature map 401B, the tracking in step S13 fails in a case where the map is switched.

In general, in a case where the tracking in step S13 once fails (step S14: NO), the same feature map 401A is first searched by performing the re-localization in step S11. Thereafter, in a case where it is found that corresponding key frames 141 do not exist (step S12: NO), map switching in step S15 is performed, and the re-localization in step S11 is performed on feature map 401B. At this time, in a case where there are many types of feature maps 401, the number of times in which the map switching is performed in step S15 increases as many as the number of types, so that a considerable amount of time is required. Therefore, in a case where moving body main body 31 rotates to the state of reference numeral 31B indicated by a solid line, moving body main body 31 is necessary to stop once until the re-localization in step S11 is successful.

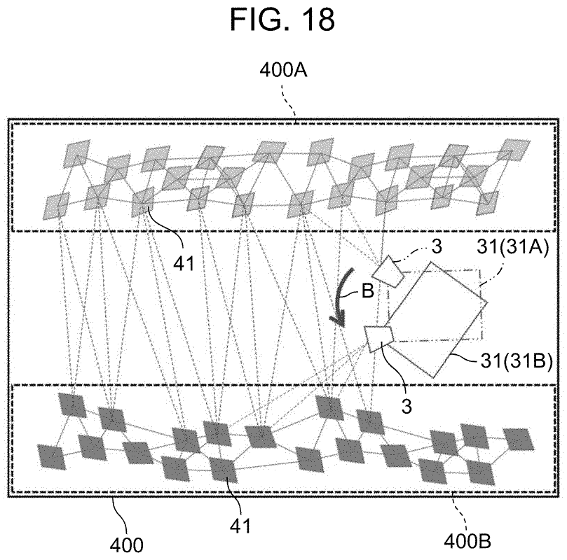

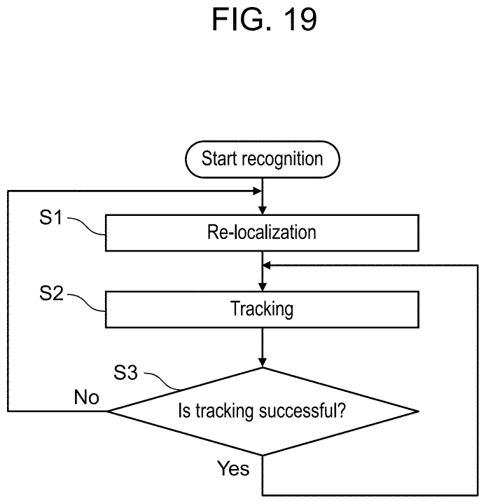

Next, the position recognition process, which is the second step in the present exemplary embodiment, will be described. As the same as in the general case described above, the case where moving body main body 31 rotates on the spot in the direction of arrow B will be described. FIG. 18 is an explanatory diagram of the position recognition process in a case where the moving body main body rotates according to the present exemplary embodiment. FIG. 19 is a flowchart showing an outline of the general position recognition process according to the present exemplary embodiment.

In the position recognition process of the present exemplary embodiment, as shown in FIG. 18, even though moving body main body 31 rotates in the direction of arrow B from the state of the reference numeral 31A indicated by a two-dot chain line to reference numeral 31B indicated by a solid line, second imaging device 3 can continue the tracking in step S3 shown in FIG. 19. A reason for this is that, unlike the general technology, in the present exemplary embodiment, feature map 400A and feature map 400B are configured as one feature map 400, so that a relative positional relationship between key frames 41 of feature map 400A and key frames 41 of feature map 400B, which each have common ORB feature value 2P, is known, as shown in FIG. 18. That is, in the present exemplary embodiment, since moving body main body 31 can rotate while continuing tracking in step S3, it is possible to rotate without temporary stop.

An overall flow of the position recognition process of the present exemplary embodiment will be described with reference to FIG. 19. In the position recognition process, position recognizer 33 performs re-localization (step S1). In step S1, position recognizer 33 performs the re-localization on feature map 400A and feature map 400B as targets. Next, position recognizer 33 performs tracking (step S2). Thereafter, position recognizer 33 determines whether or not the tracking is successful (step S3). In a case where position recognizer 33 determines that the tracking is successful (step S3: YES), drive controller 36 moves moving body main body 31 by a predetermined distance. At this time, position recognizer 33 searches the image of second imaging device 3 for a point having the same ORB feature value 2P as common ORB feature value 2P included in feature map 400A and feature map 400B, and estimates the position of moving body main body 31 based on the position of the found point in the image and a positional relationship between key frames 41 having common ORB feature value 2P in feature map 400A and feature map 400B. After that, position recognizer 33 performs the tracking again (step S2). On the other hand, in a case where position recognizer 33 determines that the tracking fails (step S3: NO), drive controller 36 stops moving body main body 31, and position recognizer 33 performs the re-localization (step S1).

Here, in the present exemplary embodiment, the map switching process of step S15 of FIG. 14 does not exist. A reason for this is that only one feature map 400 exists. Further, another reason is that the position of moving body main body 31 can be estimated based on the positional relationship between key frames 41 having common ORB feature value 2P in feature map 400A and feature map 400B and the position of the point having common ORB feature value 2P in the image of second imaging device 3. Further, since only one feature map 400 exists, the number of times that tracking in step S2 fails (step S3: NO) is less, and the number of times that re-localization in step S1 is performed is less. That is, the re-localization is performed only in a case where a surrounding environment changes and the tracking in step S2 fails (step S3: NO). Therefore, the position can be estimated at high speed, and the position can be continuously estimated even though moving body main body 31 moves straight, rotates, or the like at high speed. That is, in a case where position estimation is performed, the position can be estimated while reducing a delay in relation to movement of moving body 300 regardless of a position and an angle of moving body 300.

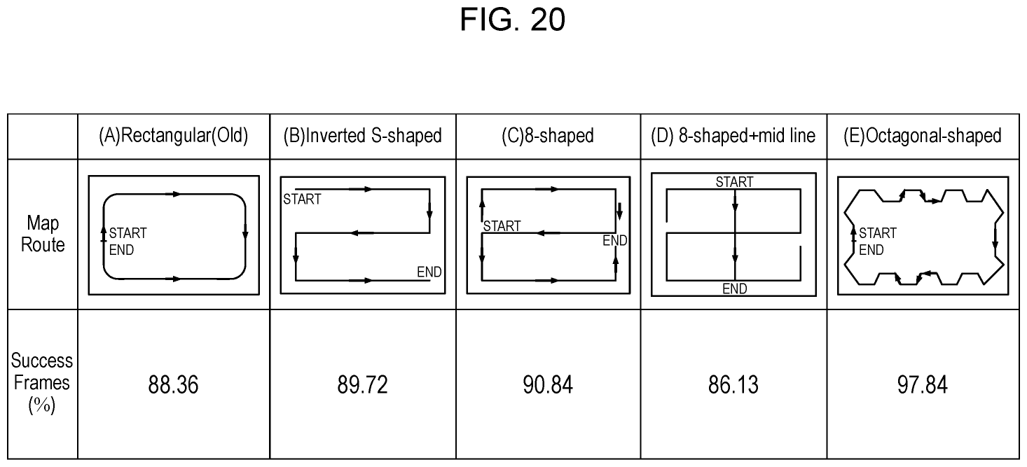

Next, experimental results of the above-described position recognition processing will be described. FIG. 20 is an explanatory diagram of the experimental results of the position recognition process.

In FIG. 20, a second line (Map Route) from top shows a diagram of the travel route of the map generation moving body in a case where feature map 400 is generated, and a first line from top shows a name of the travel route represented by the second line, and a third line from top (Success Frames (%)) shows a rate at which self-position estimation is possible (a success rate of self-position estimation) in a case where the position recognition process of the moving body 300 is performed using feature map 400 generated by the travel route on the second line. In a case where moving body 300 travels on travel routes A to E, angle γ is not particularly set and only an operation at each connection point included in travel routes A to E, which satisfies the relationship of “ε<γ”, is performed.

As shown in the third line from top of FIG. 20, the success rate of self-position estimation of the travel route E is clearly higher than those of the other routes (97.84%). It can be said that a reason for this is that the travel route E is a route that the connection point simultaneously satisfies the threshold value D related to the distance and γ related to the angle. Here, since four first imaging devices 2 are disposed so that angle α shown in FIG. 3A becomes 90°, a route such as E became a route having the highest success rate of self-position estimation. However, in a case where the number of first imaging devices 2 are changed into 6, 8, or the like, a shape of an optimum travel route (which has the highest success rate of self-position estimation) changes.

According to the position estimation system of the present disclosure, the position of the moving body can be estimated without being delayed in relation to the movement of the moving body.

The position estimation system of the present disclosure can be utilized in fields of autonomous mobile robots and automatic driving.

What is claimed is:

1. A position estimation system comprising:
a prior map creator that creates a plurality of environmental maps using a first capture; and
a position recognizer that estimates a position of a moving body based on a plurality of feature points included in the plurality of environmental maps and a feature point included in image information from a second capture provided in the moving body, wherein
the first capture includes a plurality of first imaging devices,
a pair of adjacent first imaging devices among the plurality of first imaging devices is disposed so that parts of imaging visual fields of the adjacent first imaging devices overlap, and
the second capture includes a second imaging device having a same imaging visual field as an imaging visual field of at least one first imaging device among the plurality of first imaging devices.

2. The position estimation system of claim 1, wherein
the prior map creator generates the plurality of environmental maps each corresponding to each of the adjacent first imaging devices based on image information from the adjacent first imaging devices, and
the position recognizer searches the image information from the second imaging device for a point having a same feature point as common feature points commonly included in the plurality of environmental maps each corresponding to each of the adjacent first imaging devices, and estimates the position of the moving body based on the point having the same feature point as the common feature points and a positional relationship between the common feature points in the environmental maps each corresponding to each of the adjacent first imaging devices.

3. The position estimation system of claim 1, wherein
the plurality of first imaging devices are disposed so that at least four common feature points are included in each of the imaging visual fields of the adjacent first imaging devices in a case where feature points that can be acquired based on the image information from each of the first imaging devices are uniformly distributed in an imaging visual field of each of the first imaging devices.
